(19) United States
(12) Patent Application Publication
(10) Pub. No.: US 2026/0356395 A1
(43) Pub. Date: Nov. 12, 2026

(54) Assistance System for Supporting a Driver of a Vehicle During a Lateral Guidance of the Vehicle While Taking Into Account a Dazzling of the Driver, Vehicle, and Method

(71) Applicant: Bayerische Motoren Werke Aktiengesellschaft, Muenchen (DE)

(72) Inventor: Christoph RESCH, Muenchen (DE)

(21) Appl. No.: 19/490,477

(22) PCT Filed: Jun. 18, 2024
(86) PCT No.: PCT/EP2024/066875

§ 371 Date: Dec. 5, 2025

(30) Foreign Application Priority Data
Jun. 21, 2023 (DE) 10 2023 116 321.3

(51) Int. Cl. B60W 60/00; B60W 40/08

(52) U.S. Cl. CPC B60W 60/0059; B60W 40/08; B60W 60/0053; B60W 2040/0818; B60W 2540/229; B60W 2555/20; B60W 2720/24

(57) ABSTRACT

An assistance system for supporting a driver of a vehicle during a lateral guidance of the vehicle. The assistance system is designed to: carry out an automatic lateral guidance of the vehicle on a lane, provide a hands-off operation, in which the driver can permanently remove their hands from the steering wheel of the vehicle, during the automatic lateral guidance, receive fatigue data, said fatigue data describing the eyelids of the driver, determine the degree of fatigue of the driver using the fatigue data, deactivate the hands-off operation if the degree of fatigue exceeds a specified fatigue threshold, estimate a current dazzling of the driver, and additionally deactivate the hands-off operation on the basis of the estimated dazzling.

### BACKGROUND AND SUMMARY

The present disclosure relates to an assistance system for supporting a driver of a vehicle during lateral guidance of the vehicle. The present disclosure also relates to a vehicle having an assistance system of this type. The present disclosure furthermore relates to a method for supporting a driver of a vehicle during lateral guidance of the vehicle.

Lane keeping assistants for vehicles are sufficiently known from the prior art. Such lane keeping assistants, which are also referred to as steering and lane keeping assistants or also as active lane keeping assistants, are used, in particular, to keep the vehicle within the lane or its own lane. Such a lane keeping assistant uses the surroundings data from at least one surroundings sensor of the vehicle in order to identify the boundaries of the lane or the roadway markings. Automated steering interventions can be conducted by way of the lane keeping assistant in order to keep the vehicle within the lane.

Additionally, assistance systems which enable so-called hands-off operation are known from the prior art. Such assistance systems permit the driver to permanently take their hands off the steering wheel during laterally guided travel. To maintain the function, it is necessary for the driver to be attentive, to observe the traffic situation and to be ready for an intervention at any time. The driver's attention is monitored in this case using a driver monitoring unit or an interior camera. In case of an error in the automated lateral guidance, it is presumed that the driver can engage immediately and can guide the vehicle back into the lane themselves.

In addition, driver fatigue is monitored in hands-off systems of this kind. The fatigue is determined here based on a movement and/or position of the driver's eyelids. For example, the degree to which the driver's eyes are open or closed is ascertained. It is thus possible to determine the driver fatigue from the degree of eye opening. If it is identified that the driver is tired, the hands-off operation is deactivated immediately and the function is only available to the driver again if the driver is identified as being awake. Only then is the function offered to the driver again and only then can the driver use the function again.

When driving toward the sun and when the sun is low at the same time, the driver is dazzled by the sun. This results in the driver closing their eyes or squinting. When evaluating the driver fatigue, it is then possible to conclude that the driver has closed their eyes and is tired. In such cases, this often results in driver fatigue being detected incorrectly. The hands-off operation is then deactivated and the operation can only be used by the driver again if they are identified as being awake. However, this may take a relatively long time when the sun is low. Therefore, the function cannot be used by the driver for a relatively long period of time while they are driving toward the low-lying sun.

An object of the present disclosure is to demonstrate a solution as to how a driver can be supported more reliably during automated lateral guidance of the vehicle.

An assistance system according to the disclosure is used to support a driver of a vehicle during lateral guidance of the vehicle. The assistance system is configured to perform automated lateral guidance of the vehicle on a roadway. The assistance system is furthermore configured to provide a hands-off operation, in which the driver can permanently take their hands off the steering wheel of the vehicle, during the automated lateral guidance. The assistance system is also configured to capture fatigue data, the fatigue data describing the eyelids of the driver. The assistance system is also configured to determine the degree of fatigue of the driver using the fatigue data. In addition, the systems system is configured to deactivate the hands-off operation if the degree of fatigue exceeds a predetermined fatigue limit value. The assistance system is also configured to estimate a current dazzling of the driver and additionally deactivate the hands-off operation on the basis of the estimated dazzling.

The assistance system is intended to be used to support the driver of the vehicle during lateral guidance of the vehicle. In particular, provision is made for the functionality of a lane keeping assistant for the functionality of automated lane-keeping to be provided by way of the assistance system. In this case, the driver of the vehicle can be supported during steering tasks. In particular, the assistance system can be used to engage in the steering system in such a way that the vehicle is kept within a lane of the roadway or the current lane.

The assistance system may have a computation device which may be formed by at least one processor, by at least one electronic control unit or similar. The computation device of the assistance system can be used to receive the surroundings data from at least one surroundings sensor of the assistance system. These surroundings data may describe the environment of the vehicle or surroundings of the vehicle. The surroundings sensor may be a camera, for example. In this case, the surroundings data may be image data. The respective lane of the roadway on which the vehicle is currently located can be identified in these surroundings data. In addition, road boundary markings of the respective lane can be identified based on the surroundings data. The road boundary markings may be, in particular, roadway markings, for example solid or dashed/broken lines. The road boundary markings may also be structural boundaries, for example a wall, a guard rail or similar.

The computation device or the assistance system can also be used to receive satellite-based position data which are provided, for example, using an appropriate receiver for a satellite-based position determination system. The receiver can be used, for example, to receive the position data from a global navigation satellite system. In particular, a so-called differential global positioning system is used, which can increase the accuracy of the position determination by emitting correction data.

Furthermore, the computation device or the assistance system can be used to receive digital map data which describe the environment of the vehicle. In particular, high-definition map data or HD maps can be used as the digital map data in order to be able to determine the current position of the vehicle. These high-definition map data can be stored in a memory or a memory device of the assistance system and/or can be received by an external device.

Provision is additionally made for the hands-off operation to be enabled by way of the assistance system during automated lateral guidance of the vehicle. In this hands-off operation, the driver can permanently take their hands off the steering wheel during automated lateral guidance. Provision is made, in particular, for fatigue of the driver to be monitored in order to maintain the hands-off operation. The fatigue data from a driver monitoring device or an interior camera can be used for this purpose. These fatigue data describe the driver's eyelids. In particular, the fatigue data can describe a movement and/or a position of the driver's eyelids. The fatigue data can also describe a degree of opening of the driver's eyes or eyelids.

The degree of fatigue of the driver can be ascertained based on the fatigue data. It is thus possible to determine whether the driver is awake and can monitor the traffic and/or the hands-off operation or whether the driver is tired. If the degree of fatigue exceeds the predetermined fatigue limit value, it can be assumed, in particular, that the driver is tired and cannot sufficiently monitor the traffic and the hands-off operation. The fatigue limit value can be defined in advance and it can describe, for example, a degree to which the eyes are open, a maximum period in which the eyes are closed or similar. If the degree of fatigue exceeds the predetermined fatigue limit value, the hands-off operation can be deactivated. The driver can be prompted to return their hands to the steering wheel. In addition, provision can also be made for activation of the hands-off operation to be enabled again only if it is identified that the degree of fatigue falls below the fatigue limit value.

In addition, provision can be made for the attentiveness of the driver to be monitored during the hands-off operation. Data from the driver monitoring device or the interior camera which describe the current gaze direction and/or the head position of the driver can be used for this purpose. The data from the driver monitoring device can be used as a basis for checking whether the driver is attentive or whether their attention is directed toward the traffic situation. If this is satisfied, the hands-off operation can be maintained in principle.

As explained in more detail below, the assistance system or the computation device can also be used to estimate the current dazzling of the driver. It is thus possible to ascertain whether and to what extent the driver is dazzled by external influences. For example, the driver can be dazzled by the sun and/or by a light source in the environment of the vehicle.

According to the present disclosure, the current extent to which the driver is dazzled is taken into account in the deactivation of the hands-off operation as a result of the driver's fatigue. When the driver is currently dazzled, this may result, in particular, in the driver at least partly closing their eyes and even squinting. This may result in it being incorrectly assumed that the degree of fatigue of the driver exceeds the fatigue limit value. In this case, the hands-off operation would be deactivated immediately even though the driver is not actually tired, only dazzled. If the estimated extent to which the driver is dazzled is taken into account in the deactivation of the hands-off operation as a result of the driver's fatigue, it is possible to prevent the function from being deactivated incorrectly or prematurely. Overall, it is thus possible to improve the support for the driver during lateral guidance of the vehicle.

In one embodiment, the assistance system is configured to adjust a period between the identification of the fatigue limit value being exceeded and the deactivation on the basis of the estimated dazzling. Provision may be made for the hands-off operation to be deactivated immediately if it is identified that the degree of fatigue exceeds the fatigue limit value and if it is identified that the driver is not currently dazzled. However, if it is identified that the driver is currently dazzled, the period or a so-called debounce time between the identification of the fatigue limit value being exceeded and the deactivation of the hands-off operation can be adjusted. The period may be between a few seconds and a few minutes, for example. The period may be increased as the dazzling increases. In this way, the timing of the deactivation can be adjusted to the current dazzling of the driver.

In another embodiment, the assistance system is configured to determine the degree of fatigue on the basis of the estimated dazzling. The estimated dazzling of the driver can thus also be included directly in the determination of the driver's fatigue or in the determination of the degree of fatigue. For example, the position of the driver's eyelids or the degree to which their eyes are closed can be estimated on the basis of the dazzling. This can be conducted individually for the driver. An appropriate neural network and/or a machine learning method can be used for this purpose. The actual fatigue of the driver can thus be determined precisely, taking into account the current dazzling of the driver. This makes it possible to prevent the hands-off function from being deactivated. It is also possible to ensure that the function can be activated by the driver. This would otherwise not be possible if the driver is assumed to be tired.

Provision may be made for a calibration to be performed when determining the driver's fatigue or when determining the degree of fatigue. For example, the identification of the fatigue when driving commences can be calibrated. The current dazzling of the driver can be taken into account in this calibration.

In another refinement, the assistance system is configured to determine an orientation of the vehicle toward the sun and/or a current position of the sun and to estimate the dazzling based on the orientation and/or the position of the sun. As already explained the assistance system may have a receiver for a global navigation satellite system, in particular for a differential global positioning system. The current travel direction of the vehicle and the current position of the vehicle or the geoposition of the vehicle can be determined based on the position data. The angle between the vehicle and the sun can then be determined using the current date and the current time. The position of the sun can also be determined based on the date, the time and the geoposition of the vehicle. The position of the sun can describe the angle of the sun above the horizon. The orientation of the vehicle with respect to the sun and the position of the sun can then be used to estimate the current dazzling of the driver.

Current weather data can also be used when estimating the dazzling of the driver. These weather data can describe, for example, whether there is cloud or similar which can affect the current dazzling. In addition, the digital map data can be used as a basis for ascertaining whether shade is provided by tall buildings or similar. Provision can also be made for data from an optical sensor to be used to determine or check the plausibility of the current dazzling of the driver.

It is also possible to estimate whether the driver is currently dazzled by light sources in the environment of the vehicle. Such light sources may be light sources from buildings and/or headlights of other road users. The data from optical sensors, surroundings sensors of the vehicle, sensors of an adaptive headlights system or similar can be used for this purpose.

A vehicle according to the disclosure comprises an assistance system according to the disclosure. The vehicle is particularly in the form of a passenger vehicle.

A method according to the disclosure is used to support a driver of a vehicle during lateral guidance of the vehicle. The method comprises performing automated lateral guidance of the vehicle on a roadway. The method also comprises providing a hands-off operation, in which the driver can permanently take their hands off the steering wheel of the vehicle. The method further comprises capturing fatigue data, the fatigue data describing the eyelids of the driver, during the automated lateral guidance. The method furthermore comprises determining the degree of fatigue of the driver using the fatigue data. The method moreover comprises deactivating the hands-off operation if the degree of fatigue exceeds a predetermined fatigue limit value. The method additionally comprises estimating a current dazzling of the driver and additionally deactivating the hands-off operation on the basis of the estimated dazzling.

Another aspect of the disclosure relates to a computer program comprising instructions which, when the program is executed by a computation device of the assistance system, cause the computation device to execute a method according to the disclosure and the advantageous refinements thereof. The disclosure additionally relates to a computer-readable storage medium comprising instructions which, when executed by the computation device of the assistance system, cause the computation device to execute a method according to the disclosure and the advantageous refinements thereof.

The preferred embodiments presented with reference to the assistance system according to the disclosure and the advantages thereof apply accordingly to the vehicle according to the disclosure, the method according to the disclosure, the computer program according to the disclosure, and the computer-readable storage medium according to the disclosure.

Further features of the disclosure result from the claims, the figures and the description of the figures. The features and combinations of features mentioned above in the description, and the features and combinations of features mentioned hereinafter in the description of the figures and/or solely shown in the figures are usable not only in the respective specified combination, but also in other combinations or alone, without departing from the scope of the disclosure.

### BRIEF DESCRIPTION OF THE DRAWINGS

FIG. 1 shows a schematic representation of a vehicle which comprises an assistance system for supporting a driver of the vehicle during lateral guidance of the vehicle;

FIG. 2 shows a schematic flowchart of a method for supporting a driver during lateral guidance of the vehicle taking into account dazzling of the driver according to a first variant; and

FIG. 3 shows a schematic flowchart of a method for supporting a driver during lateral guidance of the vehicle taking into account dazzling of the driver according to a second variant.

### DETAILED DESCRIPTION OF THE DRAWINGS

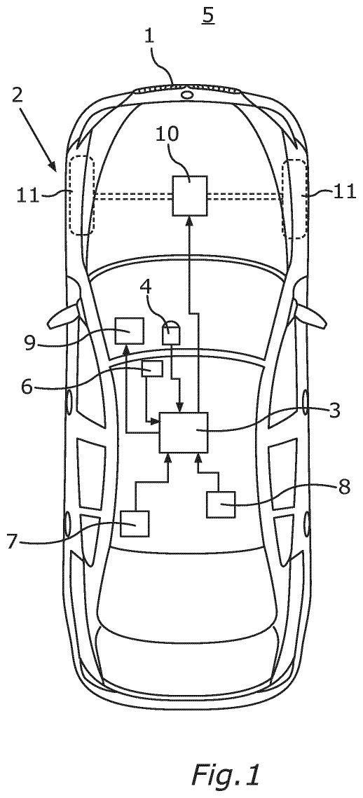

FIG. 1 shows a top view of a vehicle 1, in the present case in the form of a passenger vehicle. The vehicle 1 comprises an assistance system 2 configured to assist a user or driver of the vehicle 1 during lateral guidance of the vehicle 1. In particular, the assistance system 2 is used to take over automated lateral guidance of the vehicle 1. The assistance system 2 can preferably support the driver during the lateral guidance of the vehicle 1 such that they can permanently take their hands off the steering wheel.

The assistance system 2 comprises a computation unit 3 which can be formed, for example, by at least one electronic control unit of the vehicle 1. The electronic control unit may comprise a processor and a memory for storage of software, logic, and/or instructions to be executed by the procesory. In addition, the assistance system 2 comprises at least one surroundings sensor 4, in the present case in the form of a camera. This surroundings sensor 4 can be used to provide surroundings data or image data which describe an environment 5 of the vehicle 1. In particular, the surroundings data or image data can describe boundaries of lanes, in particular roadway markings of a roadway. The surroundings data can be transmitted from the surroundings sensor 4 or the camera to the computation unit 3. Moreover, provision may be made for the assistance system 2 to comprise additional surroundings sensors, such as radar sensors, lidar sensors or similar.

Furthermore, the assistance system 2 comprises a receiver 7 for a satellite-based position determination system. Satellite-based position data which describe the position of the vehicle 1 can be received by way of the receiver 7. In addition, the assistance system 2 comprises a memory device 8 in which high-definition map data or so-called HD maps are stored. Moreover, the assistance system 2 comprises an output device 9, by way of which an output can be output to the driver of the vehicle 1. This output can in principle be output optically, acoustically and/or haptically.

In addition, the assistance system 2 comprises a driver monitoring device 6, by way of which the attentiveness of the driver can be monitored. In particular, the driver monitoring device 6 can be used to determine data which describe a gaze direction and/or orientation of the head of the driver. In addition, the driver monitoring device 6 can be used to provide fatigue data and transmit same to the computation device 3. The fatigue data describe a lid position or a degree to which the driver's eyes are open. The computation device 3 can take the fatigue data as a basis for determining whether the driver is tired. In particular, it is possible to check whether the degree of fatigue exceeds a predetermined fatigue limit value.

The computation device 3 is furthermore configured to actuate a steering system 10 of the vehicle 1, which is illustrated only schematically here. The actuation of the steering system 10 can support the driver of the vehicle 1 during lateral guidance. In this case, steerable wheels 11 of the vehicle 1 can be moved by actuating the steering system 10. In addition, provision is preferably made for the computation device 3 to also be used to actuate a drive motor and/or a braking system of the vehicle 1 in order to also intervene in longitudinal guidance of the vehicle 1.

In this case, provision is additionally made for a hands-off operation in which the driver can permanently take their hands off the steering wheel to be made possible during automated lateral guidance of the vehicle 1. During the hands-off operation, the attentiveness and the fatigue of the driver is monitored, in particular, using the data from the driver monitoring device 6. The hands-off operation is deactivated if it is identified that the driver is tired.

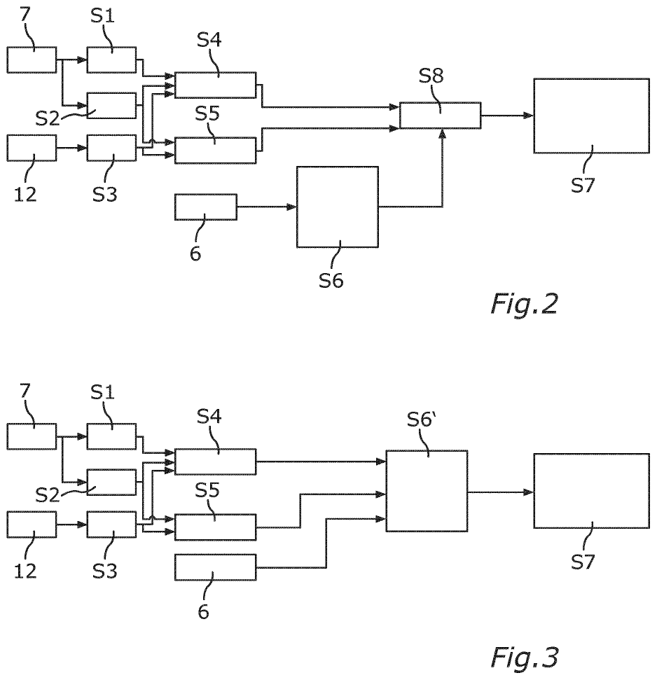

FIG. 2 shows a schematic flowchart of a method for supporting a driver during longitudinal guidance of the vehicle 1 according to a first variant. In a step S1, the position data received by the receiver 7 are used to determine the current orientation of the vehicle 1. In a step S2, the position data are taken as a basis for determining the current position or the geoposition of the vehicle 1. In a step S3, the current date and the current time are determined. Data from a clock 12 in the vehicle 1 are received for this purpose.

In a step S4, an angle between the vehicle 1 and the sun is determined using the orientation of the vehicle 1, using the geoposition of the vehicle 1 and using the date and the time. Furthermore, in a step S5, the position of the sun or the angle of the sun above the horizon is determined using the geoposition of the vehicle 1 and the date and time. To determine the angle between the vehicle 1 and the sun and to determine the position of the sun, it is possible to draw on corresponding data or calculation rules stored in the memory device 8, for example.

In a step S6, the degree of fatigue of the driver is then determined using the fatigue data from the driver monitoring device 6. If it is identified that the degree of fatigue exceeds the predetermined fatigue limit value, the hands-off operation is deactivated in a step S7 In a step S8, a period between the identification of the fatigue of the driver or the exceeding of the fatigue limit value and the deactivation of the hands-off operation is ascertained. This period or debounce time is determined on the basis of the relative position of the vehicle 1 with respect to the sun and the position of the sun. If, for example, it is identified that the vehicle 1 is moving toward the sun directly at an angle of 0° and the sun is at an angle of less than 20° above the horizon, a fatigue is then debounced over 2 minutes, for example, before the function is deactivated. If, on the other hand, it is identified that the vehicle 1 is moving toward the sun at an angle of 45° and the sun is at an angle of less than 20° above the horizon, then a fatigue is debounced over 1 minute, for example, before the function it deactivated. If, on the other hand, it is identified that the vehicle 1 is moving away from the sun at an angle of 180°, then fatigue is immediately identified and the hands-off operation is deactivated. In this case, the angle of the sun above the horizon is not important because the vehicle 1 is moving in precisely the opposite direction.

FIG. 3 shows a schematic flowchart of a method for supporting a driver during lateral guidance of the vehicle 1 according to a second variant. In this case, in comparison to the method according to FIG. 2, the angle between the vehicle 1 and the sun and the angle of the sun above the horizon are directly included in the calculation of the fatigue for the degree of fatigue according to a step S6′ of the method. A neural network can be used for this purpose, for example.

1-6. (canceled)

7. An assistance system for supporting a driver of a vehicle during lateral guidance of the vehicle, the assistance system configured to:
perform automated lateral guidance of the vehicle on a roadway,
provide a hands-off operation, in which the driver can permanently take their hands off the steering wheel of the vehicle, during the automated lateral guidance,
capture fatigue data, the fatigue data describing the eyelids of the driver,
determine the degree of fatigue of the driver using the fatigue data,
deactivate the hands-off operation if the degree of fatigue exceeds a predetermined fatigue limit value,
estimate a current dazzling of the driver, and
deactivate the hands-off operation on the basis of the estimated dazzling.

8. The assistance system according to claim 7, wherein
the assistance system is configured to adjust a period between the identification of the fatigue limit value being exceeded and the deactivation on the basis of the estimated dazzling.

9. The assistance system according to claim 7, wherein
the assistance system is configured to determine the degree of fatigue on the basis of the estimated dazzling.

10. The assistance system according to claim 7, wherein
the assistance system is configured to determine an orientation of the vehicle toward the sun and/or a current position of the sun and to estimate the dazzling based on the orientation and/or the position of the sun.

11. A vehicle comprising an assistance system according to claim 7.

12. A method for supporting a driver of a vehicle during lateral guidance of the vehicle comprising the steps of:
performing automated lateral guidance of the vehicle on a roadway,
providing a hands-off operation, in which the driver can permanently take their hands off the steering wheel of the vehicle,
capturing fatigue data, the fatigue data describing the eyelids of the driver, during the automated lateral guidance,
determining the degree of fatigue of the driver using the fatigue data,
deactivating the hands-off operation if the degree of fatigue exceeds a predetermined fatigue limit value,
estimating a current dazzling of the driver, and
deactivating the hands-off operation on the basis of the estimated dazzling.
